(19) United States
(12) Patent Application Publication
(10) Pub. No.: US 2010/0273384 A1
(43) Pub. Date: Oct. 28, 2010

(54) METHOD FOR ALIGNING A LAMP ARC IN AN OPTICAL DEVICE

(75) Inventors: PATRIK AKERSTROM, MARSTA (SE); MIKAEL HORNQVIST, VATTHOLMA (SE); STIG TORMOD, UPPSALA (SE)

Correspondence Address: GE HEALTHCARE BIO-SCIENCES CORP.;PATENT DEPARTMENT, 101 CARNEGIE CENTER, PRINCETON, NJ, 08540, US

(73) Assignee: GE HEALTHCARE BIO-SCIENCES AB, UPPSALA (SE)

(21) Appl. No.: 12/765,266

(22) Filed: Apr. 22, 2010

(30) Foreign Application Priority Data
Apr. 27, 2009 (SE) 0950282-4

(51) Int. Cl. H01J 9/44

(52) U.S. Cl. 445/4

(57) ABSTRACT

In a method for aligning the arc of a lamp with the optical axle of an optical device the lamp is inserted in a housing of a solid material, said housing having an outer configuration unambiguously adapted to a holder of the unit. The lamp is thereafter adjusted to its correct position with regard to said optical axle and fixed in said position.

### FIELD OF THE INVENTION

The present invention pertains to a method for positioning the arc of a lamp in an optical device. More specifically it pertains to a method for aligning the arc of a lamp with the optical axle of an optical device, e.g. a monochromator in an HPLC (High Performance Liquid Chromatography) system.

### BACKGROUND OF THE INVENTION

In optical instruments, where light is generated from an arc in a lamp such as a xenon flash lamp, it is crucial that the arc of the lamp is positioned on the optical axle of the system with a very high precision, typically +/−0.1 mm in order to generate a maximum light yield for obtaining a satisfactory measuring result.

However, in a lamp, such as a flash lamp, the electrodes and thus the arc are not located with such high precision within the lamp bulb. Therefore the position of the whole bulb is to be adjusted before it is fixed onto the part of the optical device on which it is mounted, such as a PCB. This, however, means that if an exchange of lamp is necessary, the whole unit which determines the exact position of the lamp has to be exchanged. This procedure can be rather troublesome and has to be performed by a service technician.

Thus there is a need for a lamp unit having an exact position of the arc and which can easily be exchanged by the user of the instrument.

### SUMMARY OF THE INVENTION

It is an object of the present invention to provide for a method for aligning the arc of a lamp with the optical axle of an optical unit. A method meeting this aspect is defined in claim 1 of the appended claims.

Further scope and applicability of the present invention will become apparent from the detailed description given hereinafter. However, it should be under-stood that the detailed description and specific examples while indicating preferred embodiment of the invention are given by way of illustration only. There are changes and modifications within the spirit and scope of the invention which will become apparent to those skilled in the art from the detailed description below.

Specifically it should be noted that the use of the method is illustrated for an optical unit e.g. for use in an HPLC system. However, the method according to the invention can be used in any optical instrument where there is a need for an exact positioning of the arc of the lamp and where the lamp could easily be exchanged.

### BRIEF DESCRIPTION OF THE DRAWINGS

The present invention will be more fully understood from the detailed description given herein including the accompanying drawing which is given by way of illustration only and is not thus limiting the present invention.

FIG. 1 shows a cross-sectional view of a lamp mounted in an optical unit, the lamp being given its correct position by using the method according to the invention.

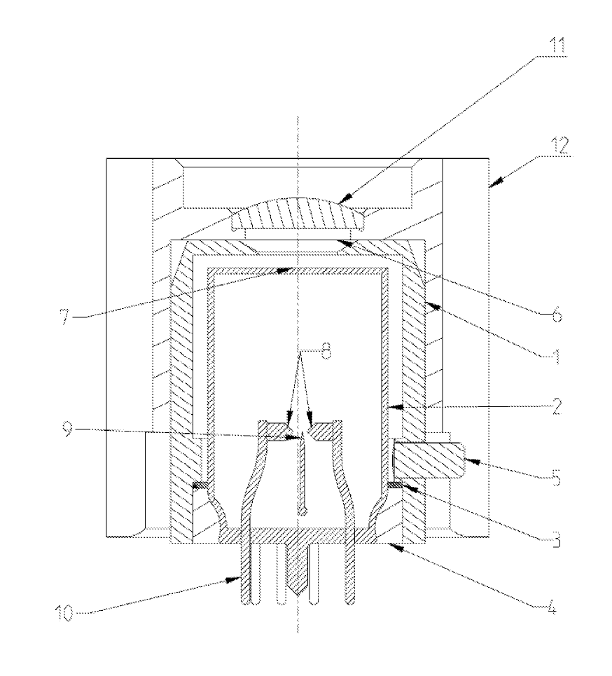

### DETAILED DESCRIPTION OF THE INVENTION

In the drawing which is a cross-sectional view of a lamp mounted in an optical unit (only partially shown) and being adjusted according to the method of the invention, reference 1 denotes a lamp housing in which a lamp (2), such as a xenon flash lamp, is arranged. Reference 3 denotes a sealing between the housing 1 and the xenon lamp 2 and reference 4 denotes a glue layer arranged between the lamp housing and the lamp. Reference 5 denotes a positioning pin of the lamp housing, reference 6 denotes a light exit of the lamp housing and reference 7 denotes a window of the lamp bulb. Furthermore references 8, 9 and 10 denote various parts of the lamp, i.e. reference 8 the electrodes, reference 9 the trigger electrode and reference 10 the electrical connections of the lamp. Finally reference 11 denotes a condenser lens of an optical unit 12 which is only partially shown and in which the lamp is mounted.

According to the invention the arc of the lamp, i.e. the arc generated between the electrodes 8, is made to coincide with the optical axis of the instrument by inserting the lamp 2 into the lamp housing 1. Thereafter the sealing 3 is arranged between the lamp housing 1 and the lamp 2. The lamp housing is provided with a positioning pin 5 so as to give the housing 1 an unambiguous position in the optical unit 12. This unambiguous position could of course be effected in many different ways. Thereafter the xenon lamp is adjusted with the help of a fixture (not shown) and the alignment is made with an alignment telescope or a microscope. In this way the lamp could be adjusted with an accuracy of +/−0.02 mm. When the correct position has been obtained the position is locked by introducing a glue 4 such as a UV curing adhesive and using a UV light source of the curing process, the sealing 3 preventing the glue from immerging into the space between the lamp and its housing. Adhesive in the shadow in the UV light can be cured e.g. by an activator.

Thus, when the lamp has been secured in the lamp housing 1 which 1 is designed so as to give it an unambiguous position in the optical unit 12 the lamp and housing unit can obviously easily be interchanged or replaced. It should also be noted that it is important to choose a suitable material for the lamp housing, thus it should have a coefficient of thermal expansion similar to that of the lamp bulb. Also if the unit 12 is to be exchanged this can be done without a change of lamp.

The invention is described above by way of an example only and could obviously be varied in many ways. Such variations are not to be regarded as a departure from the spirit and scope of the invention and all such modifications as will be obvious to anyone skilled in the art are intended to be included in the scope of the following claims.

What is claimed is:

1. A method for aligning the arc of a lamp with the optical axle of an optical device, wherein the lamp (2) is inserted in a lamp housing (1), said housing (1) having an outer configuration unambiguously adapted to the lamp housing holder part (12) of the device, the lamp (2) thereafter being adjusted to its correct position with respect to said optical axle of the device and fixed in said position.

2. The method of claim 1, wherein said fixation is made by means of a glue introduced in part of the space between said housing (1) and said lamp (2).

3. The lamp (2) and a housing (1) wherein they are adjusted in relation to each other by using the method of claim 1.

4. The lamp (2) and a housing (1) of claim 3, wherein that part of the space between the lamp and the housing is sealed by a sealing gasket (3).

5. The lamp (2) and a housing (1) of claim 3, wherein the housing and the lamp have substantially the same thermal expansion coefficient.

6. The lamp (2) and a housing (1) of claim 3, wherein the fixation is made by a UV curing adhesive.
